(19) United States
(12) Patent Application Publication
(10) Pub. No.: US 2025/0128768 A1
(43) Pub. Date: Apr. 24, 2025

(54) Work Vehicle

(71) Applicant: Kubota Corporation, Osaka-shi (JP)

(72) Inventors: Shinya Tabata, Osaka (JP); Seigi Aratake, Osaka (JP)

(21) Appl. No.: 18/914,356

(22) Filed: Oct. 14, 2024

(30) Foreign Application Priority Data
Oct. 18, 2023 (JP) 2023-179844

(51) Int. Cl. B62D 25/14; B60H 1/00

(52) U.S. Cl. CPC B62D 25/142; B60H 1/00357

(57) ABSTRACT

A work vehicle includes a body provided with a panel configured to be equipped with an air conditioner, the panel having at least one first opening and a second opening through each of which air supplied from the air conditioner flows out toward one or more occupants, and the second opening being provided with one of a duct extending from the second opening to the air conditioner and a cover blocking the second opening.

### CROSS-REFERENCE TO RELATED APPLICATION

This application claims priority to Japanese Patent Application No. 2023-179844 filed Oct. 18, 2023, the disclosure of which is hereby incorporated by reference in its entirety.

### BACKGROUND OF THE INVENTION

### 1. Field of the Invention

The present invention relates to the configuration of cabin air conditioning in a work vehicle provided with a cabin for an operator.

### 2. Description of Related Art

In a multipurpose work vehicle, which is an example of a work vehicle provided with a cabin, the cabin has a panel in a front portion of the interior thereof, and in front of the panel is an air conditioner, with air for cooling (heating) supplied from the air conditioner flowing out toward the interior of the cabin through openings in the panel, as disclosed in JP 2008-120249A.

JP 2008-120249A is an example of related art.

In a work vehicle provided with a cabin and an air conditioner, both cooling and heating may be required, or cooling may be required and heating may not be required, depending on factors such as the country or region in which the work vehicle is used.

In this case, two types of the panel in the front portion of the cabin interior may be prepared in the production of work vehicles, namely, a panel that supports both cooling and heating and a panel that supports only cooling, and thus there is room for improvement in terms of reducing the production cost of work vehicles.

### SUMMARY OF THE INVENTION

An object of the present invention is to reduce the production cost of work vehicles provided with a cabin and an air conditioner.

In order to achieve the above object, an aspect of the present invention is directed to a work vehicle including a body provided with a panel configured to be equipped with an air conditioner, the panel having at least one first opening and a second opening through each of which air supplied from the air conditioner flows out toward one or more occupants, and the second opening being provided with one of a duct extending from the second opening to the air conditioner and a cover blocking the second opening.

In the above aspect, preferably the panel extends from a right portion to a left portion of the body, the at least one first opening includes a right first opening provided in a right portion of the panel and a left first opening provided in a left portion of the panel, and the second opening is provided in a portion of the panel between the right and left first openings.

In the above aspect, preferably the second opening is larger than the at least one first opening in left-right width.

In the above aspect, preferably the panel includes a storage compartment provided in a portion thereof above the second opening and between the right and left first openings.

In the above aspect, preferably the work vehicle further includes a cabin for an operator, and the panel is provided in a front portion of an interior of the cabin.

In the above aspect, preferably the air conditioner supports both cooling and heating, cooling air supplied from the air conditioner flows out toward the one or more occupants through the at least one first opening, and heating air supplied from the air conditioner flows out toward to the one or more occupants through the second opening, and the second opening is provided with the duct.

In the above aspect, preferably the air conditioner supports cooling only, cooling air supplied from the air conditioner flows out toward the one or more occupants through the at least one first opening, and the second opening is provided with the cover.

In order to achieve the above object, an aspect of the present invention is directed to a work vehicle including a cabin for an operator, a panel provided in a front portion of an interior of the cabin, and an air conditioner provided in front of the panel. The panel has at least one first opening through which cooling air supplied from the air conditioner flows out toward the interior of the cabin, and a second opening through which heating air supplied from the air conditioner flows out toward the interior of the cabin. Also, the second opening is provided with one of a duct extending from the second opening to the air conditioner and a cover blocking the second opening.

According to the above aspect, in the case of producing a work vehicle that supports both cooling and heating, the producer installs a panel in which the second opening is provided with a duct in the front portion of the cabin interior.

Cooling air of the air conditioner is thereby supplied to the cabin interior through the at least one first opening of the panel. Also, heating air of the air conditioner is supplied to the cabin interior through the second opening of the panel via the duct of the panel.

In the case of producing a work vehicle that supports only cooling, the producer installs a panel in which the second opening is provided with a cover in the front portion of the cabin interior.

Cooling air of the air conditioner is thereby supplied to the cabin interior through the at least one first opening of the panel. Also, in this case, the second opening of the panel is blocked by the cover, and thus this configuration does not inconvenience the operator in the cabin and is also preferable in terms of panel design.

According to the above aspect, in work vehicles provided with a cabin and an air conditioner, the panel that is installed in the front portion of the cabin interior can be standardized for use in producing work vehicles that supports both cooling and heating and work vehicles that supports only cooling, thus enabling the production cost of the work vehicles to be reduced.

In the above aspect, preferably the panel extends from a right portion to a left portion of the cabin, the at least one first opening includes a right first opening provided in an upper right portion of the panel and a left first opening provided in an upper left portion of the panel, and the second opening is provided in a lower portion of the panel, between the right and left first openings.

According to the above aspect, the panel extending from the right portion to the left portion of the cabin is relatively large. The first openings are provided in upper right and upper left portions of the panel, with one of the right and left first openings of the panel corresponding to the driver's seat, and the other of the right and left first openings of the panel corresponding to the passenger seat.

According to the above aspect, the second opening is in a lower portion of the panel, between the right and left first openings.

When supplying heating air of the air conditioner to the interior of the cabin through the second opening of the panel, the heating air is thereby easily supplied to both the driver's seat and the passenger seat, thus enabling the heating air of the air conditioner to be efficiently supplied to the driver's seat and the passenger seat, even if there is one or a small number of second openings of the panel.

In the above aspect, preferably the second opening is larger than the at least one first opening in left-right width.

According to the above aspect, since the left-right width of the second opening of the panel is larger than the left-right width of the at least one first opening of the panel, the heating air is easily supplied from the second opening of the panel to both the driver's seat and the passenger seat, with this configuration being advantageous in terms of efficiently supplying heating air to the driver's seat and the passenger seat.

In the above aspect, preferably the panel includes a storage compartment provided in a portion thereof above the second opening and between the right and left first openings.

According to the above aspect, an unused area is available in the portion of the panel above the second opening, as a result of the second opening being provided in a lower portion of the panel, between the right and left first openings, and thus a storage compartment is provided in this unused area.

The arrangement of the first openings and the second opening in the panel is thereby effectively utilized to readily provide a storage compartment in the panel.

### BRIEF DESCRIPTION OF THE DRAWINGS

FIG. 1 is a side view of the left side of a work vehicle.

FIG. 2 is a rear view of a panel and a storage compartment.

FIG. 3 is a rear view of the vicinity of the panel when the work vehicle is equipped with an air conditioner that supports both cooling and heating.

FIG. 4 is a plan view of the vicinity of the panel when the work vehicle is equipped with an air conditioner that supports both cooling and heating.

FIG. 5 is a left-side longitudinal sectional view of the vicinity of a duct of the panel when the work vehicle is equipped with an air conditioner that supports both cooling and heating.

FIG. 6 is a rear view of the vicinity of the panel when the work vehicle is equipped with an air conditioner that supports cooling only.

FIG. 7 is a plan view in the vicinity of the panel when the work vehicle is equipped with an air conditioner that supports cooling only.

FIG. 8 is a left-side longitudinal view of the vicinity of a cover of the panel when the work vehicle is equipped with an air conditioner that supports cooling only.

### DESCRIPTION OF THE INVENTION

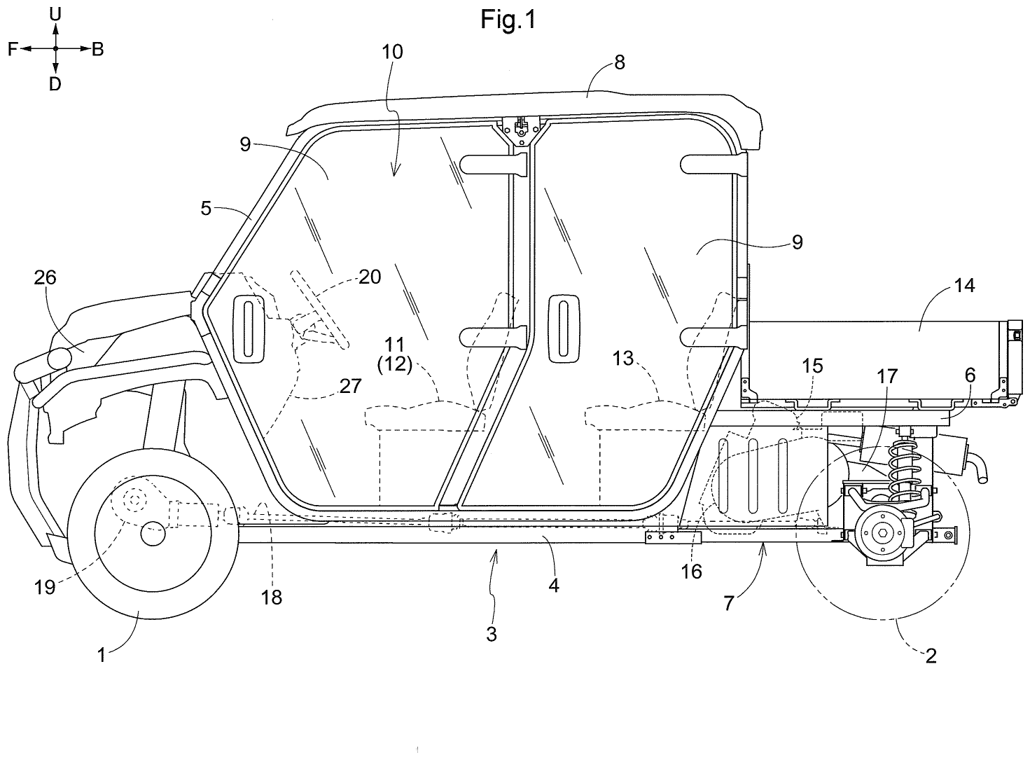

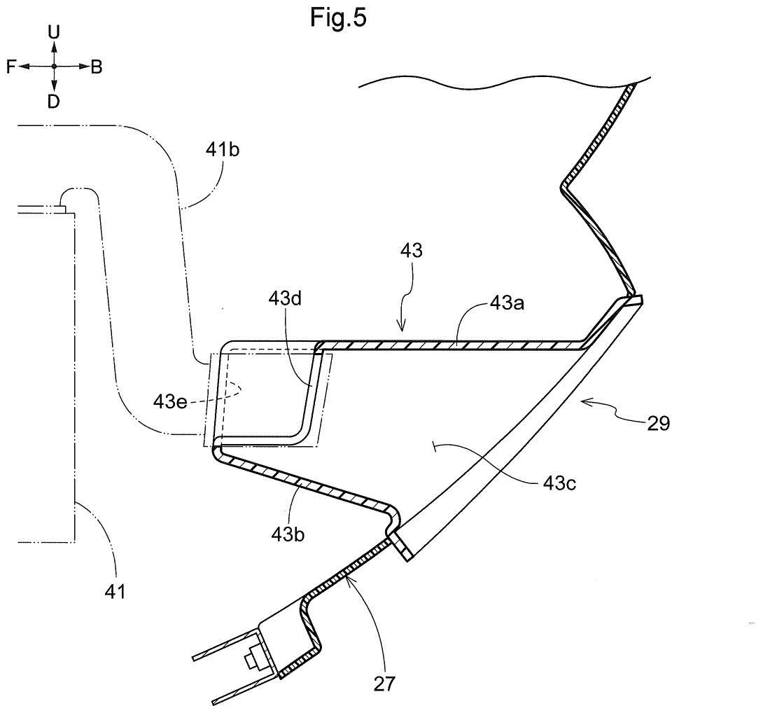

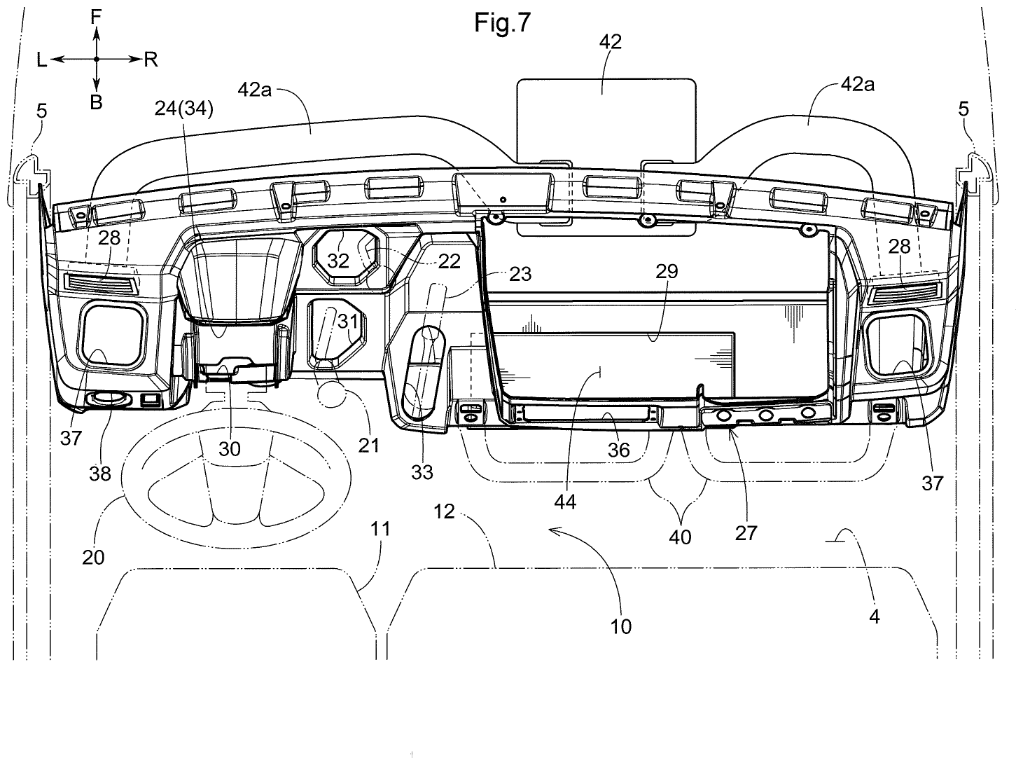

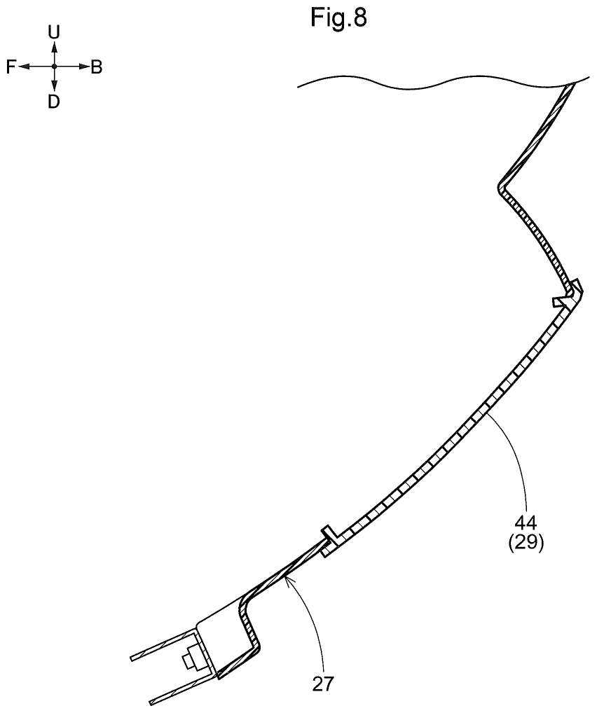

FIGS. 1 to 8 show a multipurpose work vehicle, which is an example of a work vehicle, and in FIGS. 1 to 8, F indicates forward, B indicates backward, U indicates upward, D indicates downward, R indicates rightward, and L indicates leftward.

### Overall Configuration of Work Vehicle

As shown in FIG. 1, the work vehicle has a body 3, in a front portion of which are provided right and left front wheels 1 and in a back portion of which are provided right and left rear wheels 2, with the body 3 being supported by the front wheels 1 and the rear wheels 2. The body 3 includes a floor frame 4, ROPS frames 5, a back frame 6, and a lower frame 7.

The ROPS frames 5 are provided with a windshield (not shown) and a rear glass (not shown) at front and back portions thereof, a roof 8 on an upper portion thereof, and doors 9 at front and back portions thereof.

The floor frame 4, the ROPS frames 5, the windshield and rear glass, the roof 8, and the front and back doors 9 enclose a cabin 10. On the floor frame 4 inside the cabin 10 are provided a driver's seat 11 and a passenger seat 12 on the front side, and a back seat 13 on the back side.

### Power Transmission Structure of Travel System

As shown in FIG. 1, the back frame 6 and the lower frame 7 are coupled to a back portion of the ROPS frames 5 and extend rearward, and the back frame 6 has a cargo bed 14 attached thereto. The lower frame 7 has an engine 15, a continuously variable transmission 16, a transmission case 17, and the rear wheels 2 attached thereto.

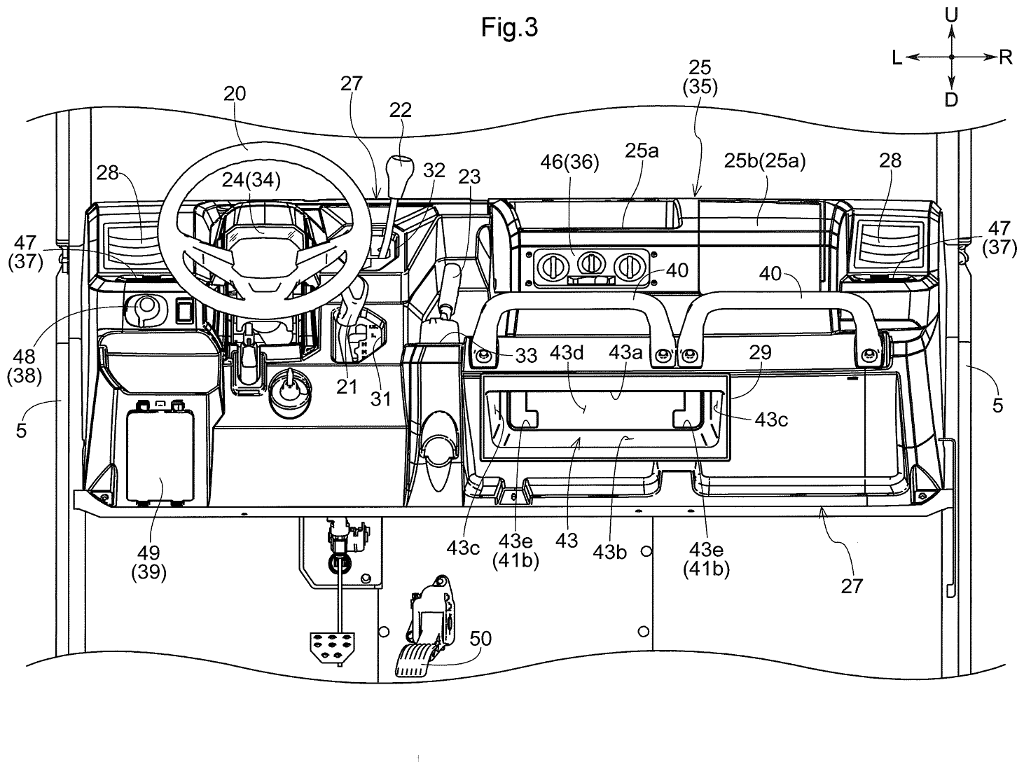

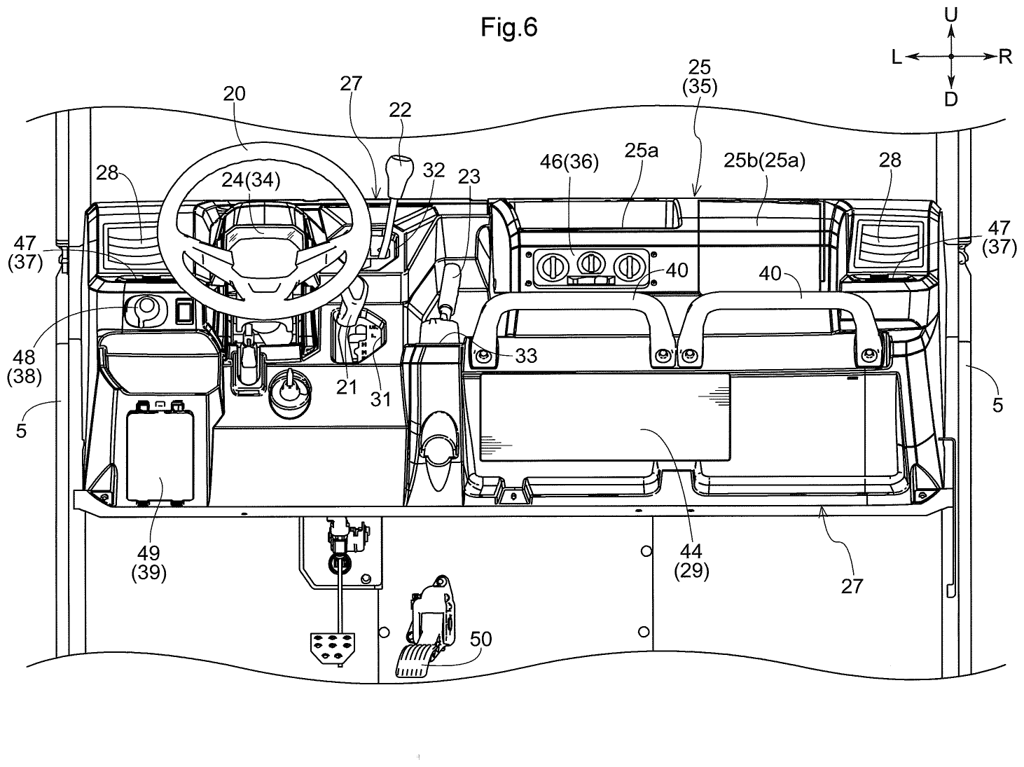

The continuously variable transmission 16 is a belt continuously variable transmission. In response to the rotational speed of the engine 15 increasing as a result of an accelerator pedal 50 (see FIGS. 3 and 6) being depressed, the continuously variable transmission 16 is automatically operated on the high-speed side. In response to the rotational speed of the engine 15 decreasing as a result of the accelerator pedal 50 being released, the continuously variable transmission 16 is automatically operated on the low-speed side.

Inside the transmission case 17 are provided a gearshift auxiliary transmission (not shown) capable of shifting through three forward gears and one reverse gear, a rear wheel differential (not shown), and a front wheel power transmission (not shown).

Power from the engine 15 is transmitted to the continuously variable transmission 16 and varied, the resulting power is then transmitted from the continuously variable transmission 16 to the auxiliary transmission and varied, and the resulting power is then transmitted from the auxiliary transmission to the rear wheel differential and from the rear wheel differential to the rear wheels 2. Power branched from between the auxiliary transmission and the rear wheel differential is transmitted to a front wheel differential 19 via the front wheel power transmission and a power transmission shaft 18, and from the front wheel differential 19 to the front wheels 1.

In response to the front wheel power transmission being operated in four-wheel drive, the front wheels 1 and the rear wheels 2 are driven as a result of power branched from between the auxiliary transmission and the rear wheel differential being transmitted to the front wheels 1.

In response to the front wheel power transmission being operated in two-wheel drive, power is cut off at the front wheel power transmission, and the rear wheels 2 are driven.

### Configuration of Operation System of Travel System

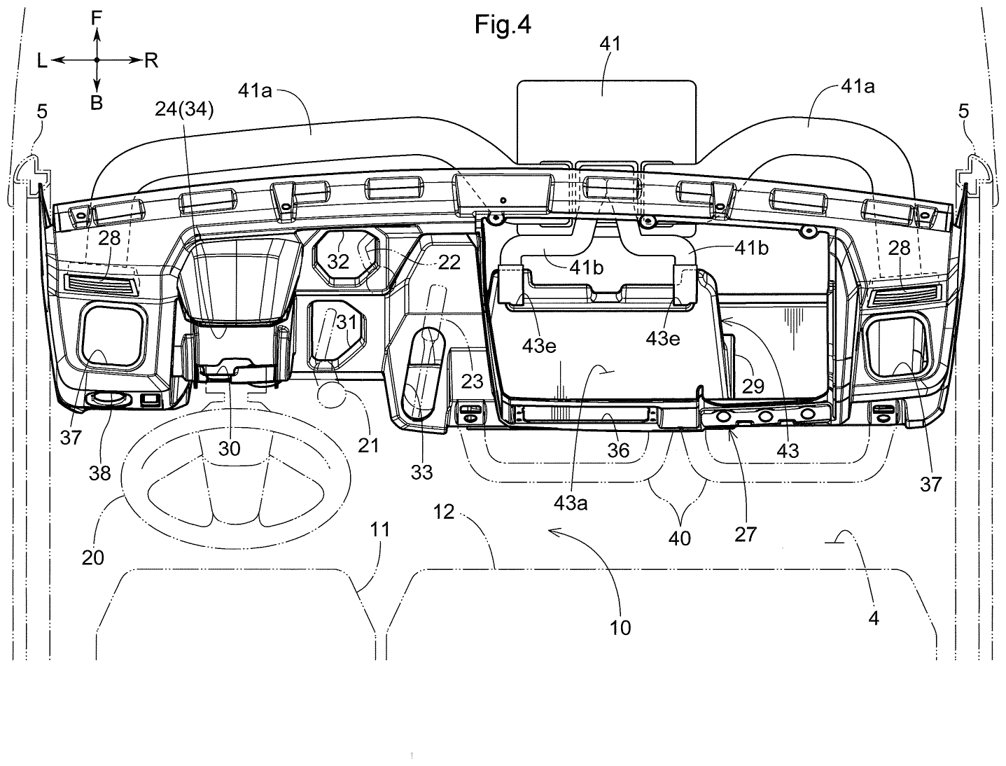

As shown in FIGS. 3 and 4, in the front portion of the interior of the cabin 10 is provided a steering wheel 20 for steering the front wheels 1. Also provided is a shift lever 21 for operating the auxiliary transmission of the transmission case 17 in the three forward gears and one reverse gear.

Also provided is a switching lever 22 for operating the front wheel power transmission of the transmission case 17 between four-wheel drive and two-wheel drive. Also provided is a parking brake lever 23 for engaging brakes (not shown) of the front wheels 1 and rear wheels 2 and keeping the brakes engaged. Also provided is a liquid crystal display panel 24 for displaying various information such as the travel speed of the body 3.

### Configuration of Panel in Front Portion of Cabin Interior

As shown in FIGS. 1, 3, and 4, a synthetic resin panel 27 is provided in the front portion of the interior of the cabin 10. The panel 27 is disposed in front of the driver's seat 11 and the passenger seat 12 and extends from the right to left ROPS frames 5 and is attached thereto.

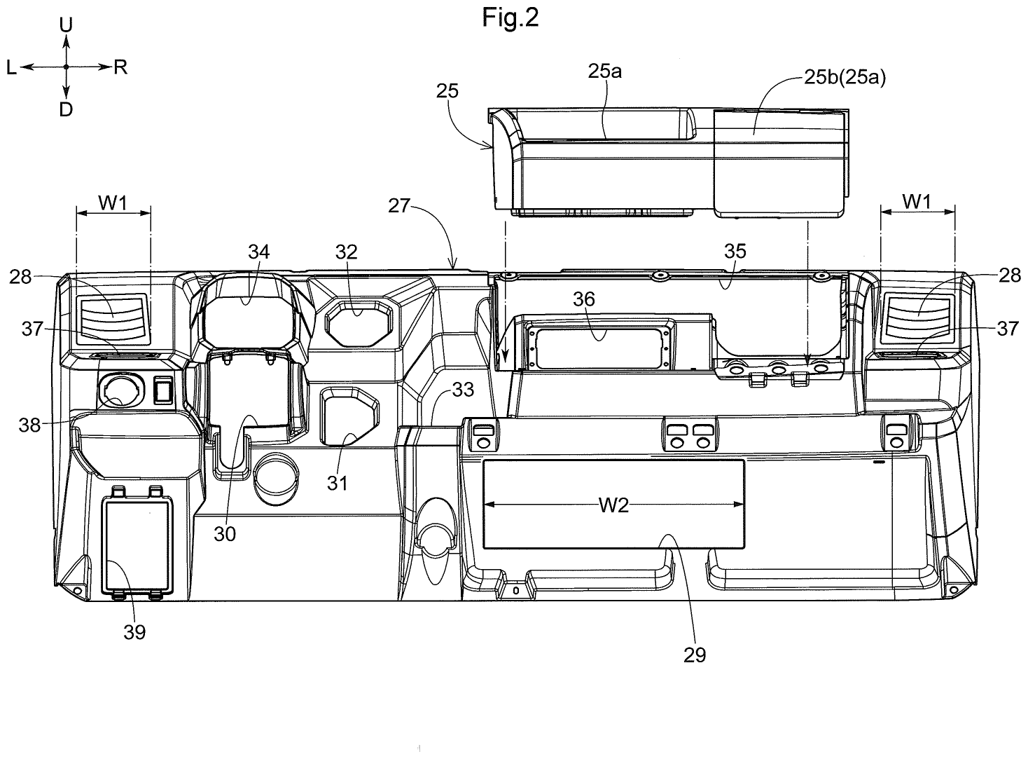

As shown in FIG. 2, the panel 27 has at least one opening 28 (corresponds to first opening), an opening 29 (corresponds to second opening), an opening 30, an opening 31, an opening 32, an opening 33, an opening 34, an opening 35, an opening 36, an opening 37, an opening 38, and an opening 39. The at least one opening 28 includes a right opening 28 provided in an upper right portion of the panel 27 and a left opening 28 provided in an upper left portion of the panel 27, and the openings 28 each have louvers (slats for directing airflow) that can be manually reoriented up/down and left/right.

The opening 29 is provided in a lower portion of the panel 27, between the right and left openings 28. The opening 29 has a left-right width W2 that is larger than a left-right width W1 of the openings 28.

The opening 30 is provided in an upper portion of the panel 27, between the left opening 28 and the opening 29.

The opening 31 is provided in an upper portion of the panel 27, between the opening 29 and the opening 30.

The opening 32 is provided in a portion of the panel 27 above the opening 31.

The opening 33 is provided in an upper portion of the panel 27, between the opening 29 and the opening 31.

The opening 34 is provided in a portion of the panel 27 above the opening 30.

The opening 35 is provided in an upper portion of the panel 27, between the right opening 28 and the openings 31 and 32.

The opening 36 is provided in an upper portion of the panel 27, below (behind) the opening 35.

The opening 37 is provided in an upper right portion and an upper left portion of the panel 27, below (behind) the openings 28.

The opening 38 is provided in an upper left portion of the panel 27, below (behind) the left opening 37.

The opening 39 is provided in a lower left portion of the panel 27, below the opening 38.

### Panel When Installed in Front Portion of Cabin Interior

As shown in FIGS. 2 and 3, the panel 27 is provided with a synthetic resin storage compartment 25 attached to the opening 35 of the panel 27. The storage compartment 25 is provided with two (right and left) recesses 25a for drinks and small items, and the right recess 25a has an openable lid 25b. The panel 27 with the storage compartment 25 attached is installed in a front portion of the interior of the cabin 10.

As shown in FIGS. 3 and 4, the opening 29 and the opening 36 on the front surface (back surface) of the panel 27 come in contact with a horizontal frame (not shown) that extends from the right to left ROPS frames 5 and is coupled thereto. In front of the passenger seat 12 are provided auxiliary handles 40 that are coupled to the horizontal frame with the panel 27 sandwiched therebetween.

In the panel 27 installed in the front portion of the interior of the cabin 10, the steering wheel 20 is provided in the opening 30 of the panel 27. The shift lever 21 is provided in the opening 31 of the panel 27. The switching lever 22 is provided in the opening 32 of the panel 27.

The parking brake lever 23 is provided in the opening 33 of the panel 27. The display panel 24 is provided in the opening 34 of the panel 27. In the opening 37 of the panel 27 is provided a drink compartment 47 (drink holder).

In the opening 38 of the panel 27 is provided a light switch 48 for turning headlights 26 (see FIG. 1) on and off. The opening 39 of the panel 27 is for inspecting and replacing electrical components and the like and has a removable cover 49 attached thereto.

### Panel When Work Vehicle Equipped With Air Conditioner Supporting Both Cooling and Heating

As shown in FIGS. 3, 4, and 5, when the work vehicle is equipped with an air conditioner 41 (air conditioning unit) that supports both cooling and heating, the air conditioner 41 is provided in front of the panel 27. The air conditioner 41 has right and left ducts 41a and right and left ducts 41b.

When the work vehicle is equipped with the air conditioner 41, the opening 29 of the panel 27 has attached thereto a duct 43 that extends forward from the opening 29 of the panel 27.

The duct 43 has a rectangular tubular shape including an upper portion 43a, a lower portion 43b, right and left horizontal portions 43c, and a front portion 43d. The front portion 43d has an opening 43e in right and left portions thereof, and the back portion (portion of the opening 29 in the panel 27) thereof is open.

When the panel 27 is installed in the front portion of the interior of the cabin 10, the right and left ducts 41a of the air conditioner 41 are respectively connected to the right and left openings 28 of the panel 27. The right and left ducts 41b of the air conditioner 41 are respectively connected to the right and left openings 43e of the duct 43. In the opening 36 of the panel 27 is provided an air conditioning switch 46 for operating the air conditioner 41.

According to the above configuration, cooling air from the air conditioner 41 is supplied to the openings 28 in the panel 27 through the ducts 41a of the air conditioner 41 and is supplied to the interior of the cabin 10 from the openings 28 in the panel 27. The cooling air is mainly supplied toward the driver's seat 11 from the left opening 28 of the panel 27 and is mainly supplied toward the passenger seat 12 from the right opening 28 of the panel 27.

Heating air from the air conditioner 41 passes through the duct 43 of the panel 27 from the ducts 41b of the air conditioner 41 and is supplied to the interior of the cabin 10 from the opening 29 of the panel 27.

In this case, heating air is efficiently supplied from the opening 29 of the panel 27 to the driver's seat 11 and the passenger seat 12, as a result of the opening 29 of the panel 27 being provided near the left-right center of the panel 27, the left-right width W2 of the opening 29 of the panel 27 being large, and the ducts 41b (openings 43e of the duct 43) of the air conditioner 41 being disposed at right and left ends of the opening 29 (duct 43) of the panel 27.

### Panel When Work Vehicle Equipped With Air Conditioner Supporting Cooling

As shown in FIGS. 6, 7, and 8, when the work vehicle is equipped with an air conditioner 42 (air conditioning unit) that supports cooling only, the air conditioner 42 is provided in front of the panel 27. The air conditioner 42 has right and left ducts 42a.

When the work vehicle is equipped with the air conditioner 42, the opening 29 of the panel 27 has attached thereto a cover 44 that blocks the opening 29 of the panel 27.

When the panel 27 is installed in the front portion of the interior of the cabin 10, the right and left ducts 42a of the air conditioner 42 are respectively connected to the right and left openings 28 of the panel 27. An air conditioning switch 46 for operating the air conditioner 42 is provided in the opening 36 of the panel 27.

According to the above configuration, cooling air from the air conditioner 42 is supplied to the openings 28 of the panel 27 through the ducts 42a of the air conditioner 42 and is supplied to the interior of the cabin 10 from the openings 28 of the panel 27. Cooling air is mainly supplied toward the driver's seat 11 from the left opening 28 of the panel 27 and is mainly supplied toward the passenger seat 12 from the right opening 28 of the panel 27.

### Correspondence of Panel With Claims

The work vehicle includes the cabin 10 for an operator, the panel 27 provided in the front portion of the interior of the cabin 10, and the air conditioner 41 or 4 provided in front of the panel 27.

The panel 27 has at least one first opening (opening 28) through which cooling air supplied from the air conditioner 41 or 42 flows out toward the interior of the cabin 10, and a second opening (opening 29) through which heating air supplied from the air conditioner 41 flows out toward the interior of the cabin 10.

The second opening (opening 29) is provided with one of the duct 43 extending from the second opening (opening 29) to the air conditioner 41 and the cover 44 blocking the second opening (opening 29).

The panel 27 extends from the right portion to the left portion of the cabin 10. The at least one first opening (opening 28) includes a right first opening provided in the upper right portion of the panel 27 and a left first opening provided in the upper left portion of the panel 27.

The second opening (opening 29) is provided in the lower portion of the panel 27, between the right and left first openings (openings 28).

The left-right width W2 of the second opening (opening 29) is set larger than the left-right width W1 of the first openings (openings 28).

The storage compartment 25 is provided in a portion of the panel 27 above the second opening (opening 29) and between the right and left first openings (openings 28).

### First Variation for Carrying Out the Invention

Rather than forming each of the panel 27, the duct 43, and the cover 44 separately, the panel 27 and the duct 43 may be integrally molded, and the cover 44 may be formed separately.

According to the aforementioned configuration, when the work vehicle is equipped with the air conditioner 41 that supports both cooling and heating, the panel 27 and the duct 43 are used without modification.

When the work vehicle is equipped with the air conditioner 42 that supports cooling only, the duct 43 is cut off from the panel 27, and the cover 44 is attached to the opening 29 of the panel 27. In this case, the panel 27 and the duct 43 may be used without modification, and the cover 44 may be attached to the opening 29 of the panel 27, without cutting off the duct 43.

### Second Variation for Carrying Out the Invention

Rather than forming the panel 27, the duct 43, and the cover 44 separately, the panel 27 and the cover 44 may be integrally molded, and the duct 43 may be formed separately. According to this configuration, the opening 29 of the panel 27 is blocked by the cover 44.

According to the aforementioned configuration, when the work vehicle is equipped with the air conditioner 41 that supports both cooling and heating, the cover 44 is cut off from the panel 27 to open the opening 29 of the panel 27, and the duct 43 is attached to the opening 29 of the panel 27.

When the work vehicle is equipped with the air conditioner 42 that supports cooling only, the panel 27 and the cover 44 are used without modification.

### Third Variation for Carrying Out the Invention

The panel 27 may be provided with two openings 29 spaced apart from each other in the left right direction.

In this case, the right and left openings 29 of the panel 27 may be spaced apart from each other by the left-right width W2 shown in FIG. 2.

According to the above configuration, when the work vehicle is equipped with the air conditioner 41 that supports both cooling and heating, a right duct 43 extends from the right duct 41b of the air conditioner 41 to the right opening 29 of the panel 27, and a left duct 43 extends from the left duct 41b of the air conditioner 41 to the left opening 29 of the panel 27.

When the work vehicle is equipped with the air conditioner 42 that supports cooling only, the right and left openings 29 of the panel 27 are respectfully provided with right and left covers 44.

### Fourth Variation for Carrying Out the Invention

When the work vehicle is equipped with the air conditioner 41 that supports both cooling and heating, cooling air from the air conditioner 41 may be supplied to the interior of the cabin 10 from the ducts 41b of the air conditioner 41 and the duct 43 and opening 29 of the panel 27, in addition to being supplied to the cabin 10 from the ducts 41a of the air conditioner 41 and the openings 28 of the panel 27.

### Fifth Variation for Carrying Out the Invention

When the work vehicle is equipped with the air conditioner 41 that supports both cooling and heating, heating air from the air conditioner 41 may be supplied to the cabin 10 from the ducts 41a of the air conditioner 41 and the openings 28 of the panel 27, in addition to being supplied to the interior of the cabin 10 from the ducts 41b of the air conditioner 41 and the duct 43 and opening 29 of the panel 27.

### Sixth Variation for Carrying Out the Invention

The work vehicle shown in FIGS. 1 to 8 is left-hand drive, but the work vehicle may right-hand drive. In the case of a right-hand drive work vehicle, the arrangement of the panel 27 and parts such as the steering wheel 20 provided in the panel 27 shown in FIGS. 2, 3, 4, 6, and 7 is horizontally reversed.

The work vehicle may be constituted without the back seat 13 and with the driver's seat 11 and the passenger seat 12 provided inside the cabin 10.

### Seventh Variation for Carrying Out the Invention

The work vehicle need not be provided with the cabin 10 for an operator, and may be constituted such that the body 3 is provided with the panel 27 configured to be equipped with the air conditioner 41 or the air conditioner 42, the panel 27 having at least one first opening 28 and a second opening 29 through each of which air supplied from the air conditioner 41 or 42 flows out toward one or more occupants, and the second opening 29 being provided with one of the duct 43 extending from the second opening 29 to the air conditioner 41 and the cover 44 blocking the second opening 29.

Also, the work vehicle may be constituted such that the panel 27 extends from the right portion to the left portion of the body 3, the at least one first opening 28 includes a right first opening 28 provided in a right portion of the panel 27 and a left first opening 28 provided in a left portion of the panel 27, and the second opening 29 is provided in a portion of the panel 27 between the right and left first openings 28.

### Industrial Applicability

The present invention is also applicable to a work vehicle provided with the front wheels 1 and a rear crawler travel device (corresponds to travel device) instead of a work vehicle provided with the front wheels 1 and rear wheels 2, and is also applicable to a work vehicle that does not have the front wheels 1 and rear wheels 2 and is provided with right and left crawler travel devices.

### LIST OF REFERENCE SIGNS

3 Body
10 Cabin
25 Storage compartment
27 Panel
28 Opening (first opening)
29 Opening (second opening)
5 41 Air conditioner
42 Air conditioner
43 Duct
44 Cover
W1 Left-right width
W2 Left-right width

What is claimed is:

1. A work vehicle comprising:
a body provided with a panel configured to be equipped with an air conditioner,
wherein the panel has at least one first opening and a second opening through each of which air supplied from the air conditioner flows out toward one or more occupants, and
wherein the second opening is provided with one of a duct extending from the second opening to the air conditioner and a cover blocking the second opening.

2. The work vehicle according to claim 1, wherein:
the panel extends from a right portion to a left portion of the body,
the at least one first opening comprises a right first opening provided in a right portion of the panel and a left first opening provided in a left portion of the panel, and
the second opening is provided in a portion of the panel between the right and left first openings.

3. The work vehicle according to claim 1,
wherein the second opening is larger than the at least one first opening in left-right width.

4. The work vehicle according to claim 2,
wherein the panel comprises a storage compartment provided in a portion thereof above the second opening and between the right and left first openings.

5. The work vehicle according to claim 1, further comprising:
a cabin for an operator, and
wherein the panel is provided in a front portion of an interior of the cabin.

6. The work vehicle according to claim 1, wherein:
the air conditioner supports both cooling and heating,
cooling air supplied from the air conditioner flows out toward the one or more occupants through the at least one first opening, and heating air supplied from the air conditioner flows out toward to the one or more occupants through the second opening, and
the second opening is provided with the duct.

7. The work vehicle according to claim 1, wherein:
the air conditioner supports cooling only,
cooling air supplied from the air conditioner flows out toward the one or more occupants through the at least one first opening, and
the second opening is provided with the cover.
